(19) United States
(12) Patent Application Publication
(10) Pub. No.: US 2025/0097882 A1
(43) Pub. Date: Mar. 20, 2025

(54) METHOD AND APPARATUS FOR LOCATION BASED GROUP FORMATION

(71) Applicant: Telefonaktiebolaget LM Ericsson (publ), Stockholm (SE)

(72) Inventors: Wenliang Xu, Shanghai (CN); Hubert Przybysz, Hägersten (SE)

(21) Appl. No.: 18/832,773

(22) PCT Filed: Jan. 19, 2023
(86) PCT No.: PCT/CN2023/073181

§ 371 Date: Jul. 24, 2024

(30) Foreign Application Priority Data
Jan. 28, 2022 (WO) PCT/CN2022/074748

(51) Int. Cl. H04W 64/00; H04W 4/50

(52) U.S. Cl. CPC H04W 64/00; H04W 4/50

(57) ABSTRACT

Embodiments of the present disclosure provide methods and apparatuses for location based group formation. A method performed by a group management server comprises receiving a location based group creation request from a group management client or a vertical application layer (VAL) server. The location based group creation request comprises location information and at least one VAL service identity (ID). The method further comprises obtaining information of at least one VAL user and/or at least one VAL user equipment (UE) corresponding to the location information. The method further comprises obtaining VAL service data of the at least one VAL user and/or the at least one VAL UE. The method further comprises creating a location based group matching the location based group creation request based on the VAL service data of the at least one VAL user and/or at least one VAL UE.

### TECHNICAL FIELD

The non-limiting and exemplary embodiments of the present disclosure generally relate to the technical field of communications, and specifically to methods and apparatuses for location based group formation.

### BACKGROUND

This section introduces aspects that may facilitate a better understanding of the disclosure. Accordingly, the statements of this section are to be read in this light and are not to be understood as admissions about what is in the prior art or what is not in the prior art.

3rd Generation Partnership Project (3GPP) TS 23.434 V17.4.0, the disclosure of which is incorporated by reference herein in its entirety, has specified the functional architecture for service enabler architecture layer (SEAL) and the procedures, information flows and APIs (Application Programming Interfaces)f or each service within SEAL in order to support vertical applications over the 3GPP system. SEAL is applicable to vertical applications using Evolved Universal Terrestrial Radio Access Network (E-UTRAN) or NR (new radio) access based on the Evolved Packet Core (EPC) or fifth generation system (5GS) architecture as defined in 3GPP TS 23.401 V17.3.0 and 3GPP TS 23.501 V17.2.0, the disclosures of which are incorporated by reference herein in its entirety. 3GPP TS 23.434 V17.4.0 specifies application plane and signaling plane entities for application-enabling services (e.g. group management, configuration management, location management, identity/key management, network resource management) that can be reused across vertical applications. SEAL also specifies the northbound APIs for its individual services to enable flexible integration with vertical applications.

FIG. 1 illustrates a generic on-network functional model for SEAL, which is same as FIG. 6.2-1 of 3GPP TS 23.434 V17.4.0. In the vertical application layer, the Vertical Application Layer (VAL) client communicates with the VAL server over VAL-UU reference point which is an instance of Uu reference point as described in 3GPP TS 23.401 V17.3.0 and 3GPP TS 23.501 V17.2.0. VAL-UU supports both unicast and multicast delivery modes. The SEAL functional entities on the user equipment (UE) and the server are grouped into SEAL client(s) and SEAL server(s) respectively. The SEAL may include a common set of services (e.g. group management, location management) and reference points. The SEAL offers its services to the vertical application layer (VAL).

The SEAL client(s) (SEAL-C) communicates with the SEAL server(s) (SEAL-S) over the SEAL-UU reference points. SEAL-UU supports both unicast and multicast delivery modes. The SEAL client(s) provides the service enabler layer support functions to the VAL client(s) over SEAL-C reference points. The VAL server(s) communicate with the SEAL server(s) over the SEAL-S reference points. The SEAL server(s) may communicate with the underlying 3GPP network systems using the respective 3GPP interfaces specified by the 3GPP network system.

One of the capabilities that SEAL provides is Configuration Management (CM). The configuration management is a SEAL service that offers the configuration management related capabilities to one or more vertical applications.

FIG. 2 illustrates an on-network functional model of SEAL for configuration management, which is same as FIG. 11.2.2-1 of 3GPP TS 23.434 V17.4.0.

The configuration management client (CMC) communicates with the configuration management server (CMS) over the CM-UU reference point reference point which utilizes Uu reference point as described in 3GPP TS 23.401 V17.3.0 and 3GPP TS 23.501 V17.2.0. The configuration management client provides the support for configuration management functions to the VAL client(s) over CM-C reference point. The VAL server(s) communicate with the configuration management server over the CM-S reference point. The configuration management server communicates with the VAL user database over the CM-VAL-UDB reference point which is an instance of VAL-UDB reference point. VAL-UDB reference point exists between the VAL user database and the SEAL server.

SEAL also supports Group Management and Location Management functions as described in 3GPP TS 23.434 V17.4.0 clause 10 and 9, respectively.

FIG. 3 illustrates a flowchart of location-based group creation, which is same as FIG. 10.3.7-1 of 3GPP TS 23.434 V17.4.0.

As described in clause 10.3.7 of 3GPP TS 23.434 V17.4.0, there are the following Pre-conditions:
1. The group management client, group management server (GMS), VAL server, location management server (LMS) and the VAL group members belong to the same VAL system.
2. The authorized VAL user/UE/administrator is not aware of the users' or UE identities which will be combined to form the VAL group.

At step 1. The group management client or the VAL server requests location-based group create operation to the group management server. The location criteria for determining the identities of the users or UEs to be combined shall be included in this message.

At step 2. The group management server requests the location management server for obtaining the users or UEs corresponding to the location information.

At step 3. The location management server composes the list of users or UEs within the requested location.

At step 4. The group management server receives the composed list of users or UEs from the location management server.

At step 5. During the group creation, the group management server creates and stores the information of the location-based group. The group management server performs the check on the policies e.g. maximum limit of the total number of VAL group members for the VAL group(s). If an external group identifier, identifying the member UEs of the VAL group at the 3GPP core network is available, then the external group ID (identity or identifier) is stored in the newly created VAL group's configuration information.

At step 6. The group management server provides a location-based group creation response to the group management client or the VAL server.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems for the existing solution of location based group formation.

Table 1 describes the information flow location-based group creation request from the group management client or VAL server to the group management server, which is same as Table 10.3.2.34-1 of 3GPP TS 23.434 V17.4.0.

TABLE 1
location-based group creation request
(corresponding to step 1 in FIG. 3)

| Information element | Status | Description |
|---|---|---|
| Requester Identity | M | The identity of the group management |
| | | client performing the request. |
| Location criteria | M | Criteria to combine Users or UEs |
| | | in a location. |
| VAL service ID list | O | List of VAL services whose service |
| (see NOTE 1) | | communications are to be enabled |
| | | on the group. |
| VAL service specific | O | Placeholder for VAL service specific |
| information | | information |
| (see NOTE 2) | | |

(NOTE 1):
This information element shall be included in the message for creating a group configured for multiple VAL services.
(NOTE 2):
The details of this information element are specified in VAL service specific specification and are out of scope of the present document.

During the location based group formation, GMS knows the VAL service ID from the VAL server or the group management client (received from the VAL server or the group management client). But when the GMS interacts with the LMS, it just receives a list of UEs within an area. Those UEs may support different VAL services so it is possible that incorrect VAL users or UEs (supporting different VAL service than the VAL server) are included into the group. It is needed to identify the supported VAL services for the retrieved UEs within an area.

A solution is that LMS can include VAL service ID together with the retrieved list of UEs to the GMS if LMS knows VAL service ID(s) (e.g. due to location information subscription procedure). However in some cases, during the location information subscription procedure, the UE may not provide its VAL service ID(s) to the LMS. In addition, LMS may know a part of VAL service ID(s) supported by a UE rather than a complete list of VAL service ID(s) supported by the UE.

In addition, in the location based UE group creation/update, it is unclear how the LMS can retrieve a list of UE identities.

To overcome or mitigate at least one above mentioned problems or other problems, the embodiments of the present disclosure propose an improved solution of location based group formation.

In an embodiment, VAL service ID may be added in Obtain UE list per location response message as shown in step 4 of FIG. 3.

In an embodiment, it proposed a new CM service for retrieving VAL service ID associated with requested VAL UE or user ID.

In an embodiment, 3GPP CN interaction for LMS is proposed to retrieve the UE ID list.

In an embodiment, if GMS doesn't receive VAL service ID for the UE from LMS, GMS can retrieve it from the CMS.

In a first aspect of the disclosure, there is provided a method performed by a group management server. The method comprises receiving a location based group creation request from a group management client or a vertical application layer (VAL) server. The location based group creation request comprises location information and at least one VAL service identity (ID). The method further comprises obtaining information of at least one VAL user and/or at least one VAL user equipment (UE) corresponding to the location information. The method further comprises obtaining VAL service data of the at least one VAL user and/or the at least one VAL UE. The method further comprises creating a location based group matching the location based group creation request based on the VAL service data of the at least one VAL user and/or at least one VAL UE.

In an embodiment, the method further comprises storing information of the location based group. The method further comprises sending a location based group creation response to the group management client or the VAL server.

In an embodiment, obtaining information of the at least one VAL user and/or the at least one VAL UE corresponding to the location information comprises sending a first request for obtaining the at least one VAL user and/or the at least one VAL UE corresponding to the location information to a location management server and receiving a first response comprising the information of the at least one VAL user and/or the at least one VAL UE corresponding to the location information from the location management server.

In an embodiment, the first response further comprises VAL service data of one or more of the at least one VAL user and/or the at least one VAL UE.

In an embodiment, obtaining VAL service data of the at least one VAL user and/or the at least one VAL UE comprises at least one of obtaining VAL service data of one or more of the at least one VAL user and/or the at least one VAL UE from a location management server; or obtaining VAL service data of one or more of the at least one VAL user and/or the at least one VAL UE from a configuration management server.

In an embodiment, obtaining VAL service data of one or more of the at least one VAL user and/or the at least one VAL UE from a configuration management server comprises when VAL service ID obtained from the location management server does not comprise one or more of the at least one VAL service identity received in the location based group creation request, obtaining the VAL service data of the VAL user or the VALUE from the configuration management server.

In an embodiment, obtaining VAL service data of one or more of the at least one VAL user and/or the at least one VAL UE from a configuration management server comprises sending a second request for obtaining the VAL service data of one or more of the at least one VAL user and/or the at least one VAL UE to the configuration management server and receiving a second response comprising the VAL service data of one or more of the at least one VAL user and/or the at least one VAL UE from the configuration management server.

In an embodiment, the second request comprises at least one of an identity of an entity performing the second request, at least one VAL user ID, at least one VAL UE ID, or at least one VAL service ID.

In an embodiment, the second response further comprises a result indicating success or failure for the second request.

In an embodiment, when the second request comprises one or more VAL service IDs, the one or more VAL service IDs are used as a first service data retrieval filter and the second response comprises the VAL service data filtered by the first service data retrieval filter.

In an embodiment, when the second request comprises one or more VAL user IDs and/or one or more VAL UE IDs, the one or more VAL user IDs and/or the one or more VAL UE IDs are used as a second service data retrieval filter and the second response comprises the VAL service data filtered by the second service data retrieval filter.

In an embodiment, when the second request comprises both the one or more VAL service IDs and the one or more VAL user IDs and/or the one or more VAL UE IDs, the one or more VAL service IDs and the one or more VAL user IDs and/or the one or more VAL UE IDs are used as a third service data retrieval filter and the second response comprises the VAL service data filtered by the third service data retrieval filter.

In an embodiment, the configuration management server has VAL service data maintained for at least one VAL user and/or at least one VAL UE.

In an embodiment, VAL service data of a VAL user or a VAL UE comprises at least one of one or more VAL service IDs of one or more VAL services supported by the VAL user or the VAL UE, a VAL user ID, a VAL UE ID, or VAL service specific information.

In a second aspect of the disclosure, there is provided a method performed by a configuration management server. The method comprises receiving a request for obtaining VAL service data of at least one VAL user and/or at least one VAL UE from a consumer. The method further comprises sending a response comprising the VAL service data of the at least one VAL user and/or the at least one VAL UE to the consumer.

In an embodiment, the request comprises at least one of an identity of an entity performing the request, at least one VAL user ID, at least one VAL UE ID, or at least one VAL service ID.

In an embodiment, the response further comprises a result indicating success or failure for the request.

In an embodiment, when the request comprises one or more VAL service IDs, the one or more VAL service IDs are used as a first service data retrieval filter and the response comprises the VAL service data filtered by the first service data retrieval filter.

In an embodiment, when the request comprises one or more VAL user IDs and/or one or more VAL UE IDs, the one or more VAL user IDs and/or the one or more VAL UE IDs are used as a second service data retrieval filter and the response comprises the VAL service data filtered by the second service data retrieval filter.

In an embodiment, when the request comprises both the one or more VAL service IDs and the one or more VAL user IDs and/or the one or more VAL UE IDs, the one or more VAL service IDs and the one or more VAL user IDs and/or the one or more VAL UE IDs are used as a third service data retrieval filter and the response comprises the VAL service data filtered by the third service data retrieval filter.

In an embodiment, the configuration management server has VAL service data maintained for at least one VAL UE and/or at least one VAL user.

In an embodiment, VAL service data of a VAL user or a VAL UE comprises at least one of one or more VAL service IDs of one or more VAL services supported by the VAL user or the VAL UE, a VAL user ID, a VAL UE ID, or VAL service specific information.

In an embodiment, the consumer comprises at least one of a group management server, a group management client, or a VAL server.

In an embodiment, the VAL service data of the at least one VAL user and/or the at least one VAL UE is used by the consumer to form a location based group with at least one desired VAL service.

In a third aspect of the disclosure, there is provided a method performed by a consumer. The method comprises sending a request for obtaining VAL service data of at least one VAL user and/or at least one VAL UE to a configuration management server. The method further comprises receiving a response comprising the VAL service data of the at least one VAL user and/or the at least one VAL UE from the configuration management server.

In an embodiment, the request comprises at least one of an identity of an entity performing the request, at least one VAL user ID, at least one VAL UE ID, or at least one VAL service ID.

In an embodiment, the response further comprises a result indicating success or failure for the request.

In an embodiment, when the request comprises one or more VAL service IDs, the one or more VAL service IDs are used as a first service data retrieval filter and the response comprises the VAL service data filtered by the first service data retrieval filter.

In an embodiment, when the request comprises one or more VAL user IDs and/or one or more VAL UE IDs, the one or more VAL user IDs and/or the one or more VAL UE IDs are used as a second service data retrieval filter and the response comprises the VAL service data filtered by the second service data retrieval filter.

In an embodiment, when the request comprises both the one or more VAL service IDs and the one or more VAL user IDs and/or the one or more VAL UE IDs, the one or more VAL service IDs and the one or more VAL user IDs and/or the one or more VAL UE IDs are used as a third service data retrieval filter and the response comprises the VAL service data filtered by the third service data retrieval filter.

In an embodiment, the configuration management server has VAL service data maintained for at least one VAL UE and/or at least one VAL user.

In an embodiment, VAL service data of a VAL user or a VAL UE comprises at least one of one or more VAL service IDs of one or more VAL services supported by the VAL user or the VAL UE, a VAL user ID, a VAL UE ID, or VAL service specific information.

In an embodiment, the consumer comprises at least one of a group management server, a group management client, or a VAL server.

In an embodiment, the VAL service data of the at least one VAL user and/or the at least one VAL UE is used by the consumer to form a location based group with at least one desired VAL service.

In a fourth aspect of the disclosure, there is provided a method performed by a location management server. The method comprises receiving a request for obtaining at least one VAL user and/or at least one VAL UE corresponding to location information from a group management server. The method further comprises sending a response comprising the information of the at least one VAL user and/or the at least one VAL UE corresponding to the location information to the group management server. The response further comprises VAL service data of one or more of the at least one VAL user and/or the at least one VAL UE.

In an embodiment, VAL service data of a VAL user or a VAL UE comprises at least one of one or more VAL service IDs of one or more VAL services supported by the VAL user or the VAL UE, a VAL user ID, or a VAL UE ID, VAL service specific information.

In a fifth aspect of the disclosure, there is provided a group management server. The group management server comprises a processor and a memory coupled to the processor. Said memory contains instructions executable by said processor. Said group management server is operative to receive a location based group creation request from a group management client or a vertical application layer (VAL) server. The location based group creation request comprises location information and at least one VAL service identity (ID). Said group management server is further operative to obtain information of at least one VAL user and/or at least one VAL user equipment (UE) corresponding to the location information. Said group management server is further operative to obtain VAL service data of the at least one VAL user and/or the at least one VAL UE. Said group management server is further operative to create a location based group matching the location based group creation request based on the VAL service data of the at least one VAL user and/or at least one VAL UE.

In a sixth aspect of the disclosure, there is provided a configuration management server. The configuration management server comprises a processor and a memory coupled to the processor. Said memory contains instructions executable by said processor. Said configuration management server is operative to receive a request for obtaining VAL service data of at least one VAL user and/or at least one VAL UE from a consumer. Said configuration management server is further operative to send a response comprising the VAL service data of the at least one VAL user and/or the at least one VAL UE to the consumer.

In a seventh aspect of the disclosure, there is provided a consumer. The consumer comprises a processor and a memory coupled to the processor. Said memory contains instructions executable by said processor. Said consumer is operative to send a request for obtaining VAL service data of at least one VAL user and/or at least one VAL UE to a configuration management server. Said consumer is further operative to receive a response comprising the VAL service data of the at least one VAL user and/or the at least one VAL UE from the configuration management server.

In an eighth aspect of the disclosure, there is provided a location management server. The location management server comprises a processor and a memory coupled to the processor. Said memory contains instructions executable by said processor. Said location management server is operative to receive a request for obtaining at least one VAL user and/or at least one VAL UE corresponding to location information from a group management server. Said location management server is further operative to send a response comprising the information of the at least one VAL user and/or the at least one VAL UE corresponding to the location information to the group management server. The response further comprises VAL service data of one or more of the at least one VAL user and/or the at least one VAL UE.

In a ninth aspect of the disclosure, there is provided a group management server. The group management server comprises a receiving module configured to receive a location based group creation request from a group management client or a vertical application layer (VAL) server. The location based group creation request comprises location information and at least one VAL service identity (ID). The group management server further comprises a first obtaining module configured to obtain information of at least one VAL user and/or at least one VAL user equipment (UE) corresponding to the location information. The group management server further comprises a second obtaining module configured to obtain VAL service data of the at least one VAL user and/or the at least one VAL UE. The group management server further comprises a creating module configured to create a location based group matching the location based group creation request based on the VAL service data of the at least one VAL user and/or at least one VAL UE.

In an embodiment, the group management server further comprises a storing module configured to store information of the location based group.

In an embodiment, the group management server further comprises a sending module configured to send a location based group creation response to the group management client or the VAL server.

In a tenth aspect of the disclosure, there is provided a configuration management server. The configuration management server comprises a receiving module configured to receive a request for obtaining VAL service data of at least one VAL user and/or at least one VAL UE from a consumer. The configuration management server further comprises a sending module configured to send a response comprising the VAL service data of the at least one VAL user and/or the at least one VAL UE to the consumer.

In an eleventh aspect of the disclosure, there is provided a consumer. The consumer comprises a sending module configured to send a request for obtaining VAL service data of at least one VAL user and/or at least one VAL UE to a configuration management server. The consumer further comprises a receiving module configured to receive a response comprising the VAL service data of the at least one VAL user and/or the at least one VAL UE from the configuration management server.

In a twelfth aspect of the disclosure, there is provided a location management server. The location management server comprises a receiving module configured to receive a request for obtaining at least one VAL user and/or at least one VAL UE corresponding to location information from a group management server. The location management server further comprises a sending module configured to send a response comprising the information of the at least one VAL user and/or the at least one VAL UE corresponding to the location information to the group management server.

In a thirteenth aspect of the disclosure, there is provided a computer program product, comprising instructions which, when executed on at least one processor, cause the at least one processor to carry out any of the methods according to the first, second, third or fourth aspects of the disclosure.

In a fourteenth aspect of the disclosure, there is provided a computer-readable storage medium storing instructions which, when executed by at least one processor, cause the at least one processor to carry out any of the method according to the first, second, third or fourth aspects of the disclosure.

Embodiments herein afford many advantages, of which a non-exhaustive list of examples follows. In some embodiments herein, the proposed solution can avoid incorrect VAL users or UEs (supporting different VAL service than the VAL server) being included into a location based group. In some embodiments herein, the proposed solution can identify the supported VAL services for the retrieved VAL users or UEs within an area. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates a generic on-network functional model for SEAL;

FIG. 2 illustrates an on-network functional model of SEAL for configuration management;

FIG. 3 illustrates a flowchart of location-based group creation;

FIG. 4a schematically shows a high level architecture in a 4G network;

FIG. 4b schematically shows a high level architecture in the fifth generation network according to an embodiment of the present disclosure;

FIG. 5 shows a flowchart of a method according to an embodiment of the present disclosure;

FIG. 6 shows a flowchart of a method according to another embodiment of the present disclosure;

FIG. 7 shows a flowchart of a method according to another embodiment of the present disclosure;

FIG. 8 shows a flowchart of a method according to another embodiment of the present disclosure;

FIG. 9 shows a flowchart of a method according to another embodiment of the present disclosure;

FIG. 10 shows a flowchart of a method according to another embodiment of the present disclosure;

FIG. 11 shows a flowchart of location area monitoring notification procedure according to an embodiment of the present disclosure;

FIG. 12 shows a flowchart of location-based group creation procedure according to an embodiment of the present disclosure;

FIG. 13 shows a flowchart of location-based group creation procedure according to another embodiment of the present disclosure;

FIG. 14 shows a flowchart of obtaining the VAL service data for VAL UE(s) or VAL user(s) according to another embodiment of the present disclosure;

FIG. 15 shows an example of Resource URI structure of the SS_VALServiceData API according to another embodiment of the present disclosure;

FIG. 16 is a block diagram showing an apparatus suitable for practicing some embodiments of the disclosure;

FIG. 17 is a block diagram showing a group management server according to an embodiment of the disclosure;

FIG. 18 is a block diagram showing a configuration management server according to an embodiment of the disclosure;

FIG. 19 is a block diagram showing a consumer according to an embodiment of the disclosure; and

FIG. 20 is a block diagram showing a location management server according to an embodiment of the disclosure.

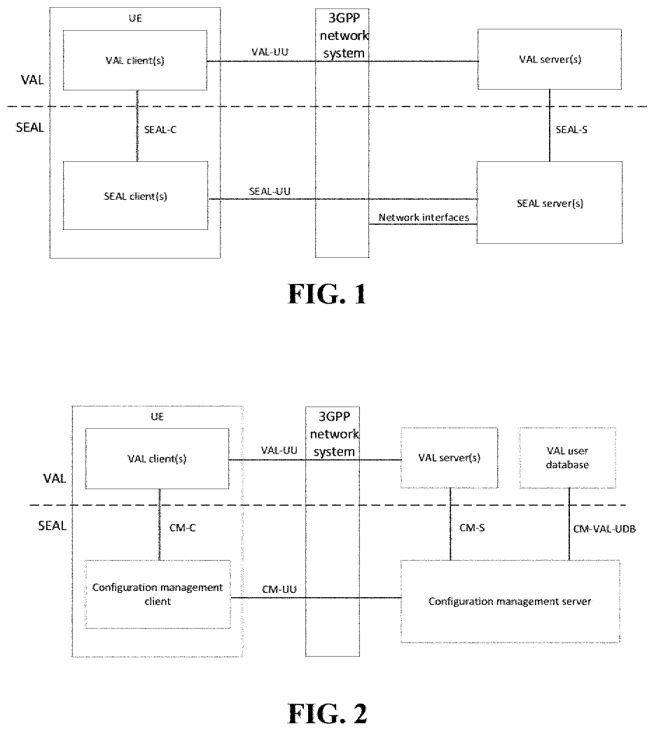

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” or “network function (NF)” refers to any suitable function which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to the cellular network as defined by 3GPP being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies such as wireless sensor network may equally be utilized as long as exemplary embodiments described herein are applicable.

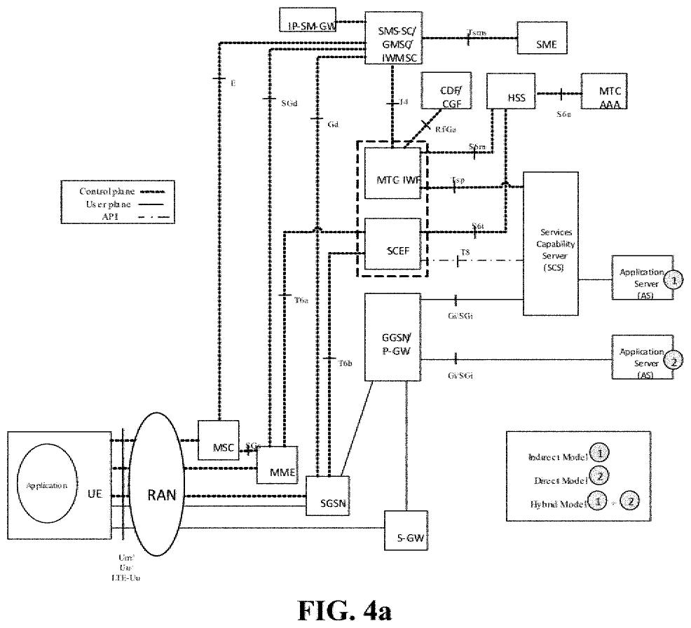

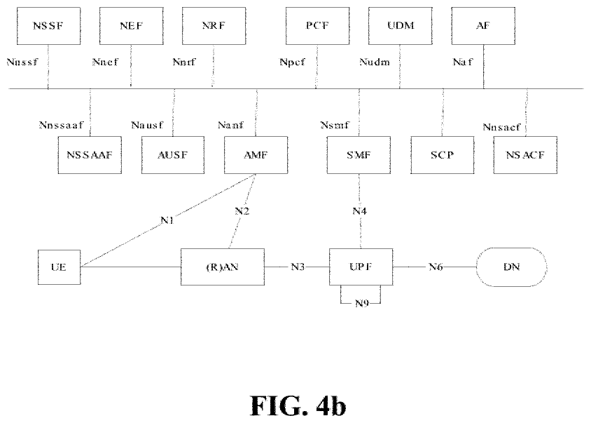

FIGS. 4a and 4b show some system architectures in which the embodiments of the present disclosure can be implemented. For simplicity, the system architectures of FIGS. 4a and 4b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 4a schematically shows a high level architecture in a 4G network, which is same as FIG. 4.2-1a of 3GPP TS 23.682 V17.2.0, the disclosure of which is incorporated by reference herein in its entirety. The system architecture of FIG. 4a may comprise some exemplary elements such as SCS (services capability server), AS (application server), SCEF, HSS (home subscriber server), UE, RAN (Radio Access Network), SGSN (Serving GPRS (General Packet Radio Service) Support Node), MME (Mobile Management Entity), MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 4a may be same as the corresponding network elements and interfaces as described in 3GPP TS 23.682 V17.2.0.

FIG. 4b schematically shows a high level architecture in the fifth generation network according to an embodiment of the present disclosure. For example, the fifth generation network may be 5GS. The architecture of FIG. 4b is same as FIG. 4.2.3-1 as described in 3GPP TS 23.501 V17.2.0, the disclosure of which is incorporated by reference herein in its entirety. The system architecture of FIG. 4b may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 4b. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 4b, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 4b also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 4b may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.2.0.

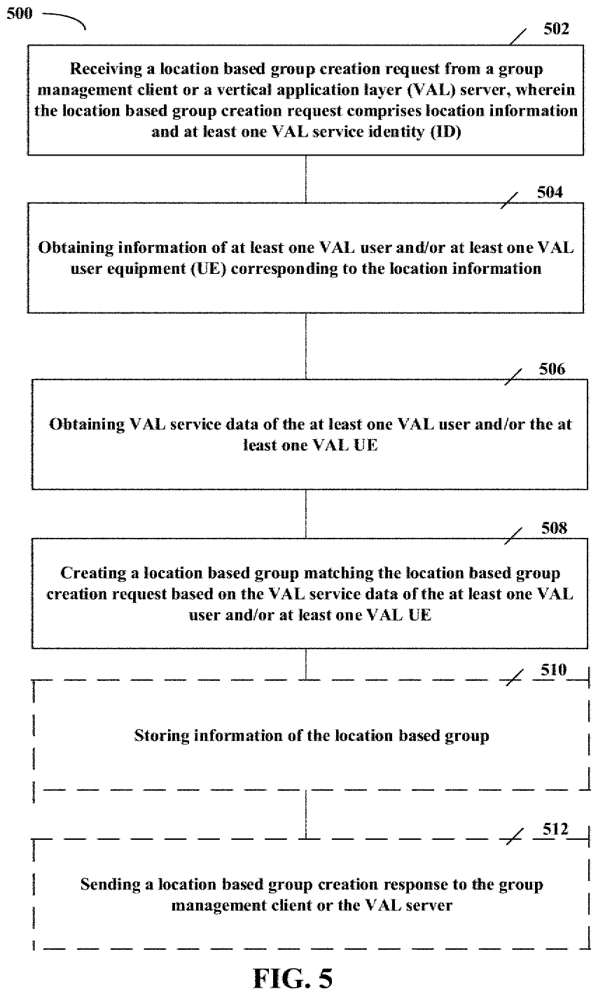

FIG. 5 shows a flowchart of a method according to an embodiment of the present disclosure, which may be performed by an apparatus implemented in or at or as a group management server or communicatively coupled to the group management server. As such, the apparatus may provide means or modules for accomplishing various parts of the method 500 as well as means or modules for accomplishing other processes in conjunction with other components.

The group management server may be any suitable function which can implement group management. For example, the group management server functional entity provides for management of groups supported within the vertical application layer. The group management server acts as Common API Framework (CAPIF)'s API exposing function as specified in 3GPP TS 23.222 V17.1.0. The group management server also supports interactions with the corresponding group management server in distributed SEAL deployments. The group management server functional entity is supported by the SIP (Session Initiation Protocol) AS (application server) and HTTP server functional entities of the signalling control plane.

All the group management clients supporting users belonging to a single group may be required to use the same group management server for that group. A group management client supporting a user involved in multiple groups can have relationships with multiple group management servers.

At block 502, the group management server may receive a location based group creation request from a group management client or a vertical application layer (VAL) server. The location based group creation request comprises location information and at least one VAL service identity (ID).

The location information may be any suitable location information and the present disclosure has no limit on it. For example, the location information may be any suitable location information which can be obtained from the 3GPP network or managed by the location management server of 3GPP TS 23.434 V17.4.0. In an embodiment, the location information may be same as the location information as described in 3GPP TS 23.434 V17.4.0.

The VAL service ID is a unique identifier that represents the VAL service. A VAL server provides a list of VAL services towards the VAL users or VAL UE. Each VAL service is uniquely identified by a VAL service ID, which is an identifier of the VAL application providing that VAL service. The VAL service ID can be used for policy mapping, QoS handling for VAL communication and VAL message distribution. For example, an identifier of a V2X service, e.g. ITS-AID or PSID specified in ETSI TS 102 965 (V1.4.1): “Intelligent Transport Systems (ITS); Application Object Identifier (ITS-AID); Registration” and ISO TS 17419: “Intelligent Transport Systems-Cooperative systems-Classification and management of ITS applications in a global context”, can be used as a V2X service ID.

The location based group creation request may be same as the corresponding request as described in Table 10.3.2.34-1 of 3GPP TS 23.434 V17.4.0.

The group management client functional entity acts as the application client for management of groups. A VAL system maintains groups corresponding to one or more vertical applications. The group management client interacts with the group management server. The group management client also supports interactions with the corresponding group management client between the two UEs. The group management client functional entity is supported by the signalling user agent and HTTP (Hyper Text Transfer Protocol) client functional entities of the signalling control plane.

The VAL server may provide the server side functionalities corresponding to the vertical applications (e.g. V2X (Vehicle to Everything) application servers). The VAL server acts as CAPIF's API invoker as specified in 3GPP TS 23.222 V17.1.0.

At block 504, the group management server may obtain information of at least one VAL user and/or at least one VAL user equipment (UE) corresponding to the location information.

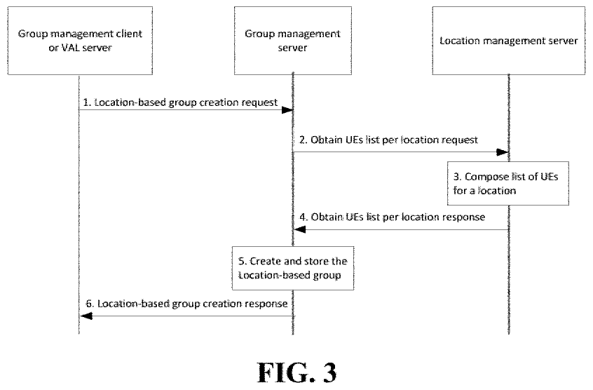

The group management server may obtain such information in various ways. For example, the group management server may obtain such information from LMS as shown in steps 2-4 of FIG. 3. Alternatively the monitoring capability for “Number of UEs present in a geographical area” provided by SCEF/NEF may be used by the group management server to retrieve all UE identifiers within the designated geographical area.

In an embodiment, the group management server may send a first request for obtaining the at least one VAL user and/or the at least one VAL UE corresponding to the location information to a location management server and receive a first response comprising the information of the at least one VAL user and/or the at least one VAL UE corresponding to the location information from the location management server.

At block 506, the group management server may obtain VAL service data of the at least one VAL user and/or the at least one VAL UE.

The VAL service data of a VAL user or a VAL UE may comprises any suitable information about the VAL service of the VAL user or the VAL UE.

In an embodiment, VAL service data of a VAL user or a VAL UE comprises at least one of one or more VAL service IDs of one or more VAL services supported by the VAL user or the VAL UE, a VAL user ID, a VAL UE ID, or VAL service specific information.

The group management server may obtain the VAL service data of the at least one VAL user and/or the at least one VAL UE in various ways. For example if the group management server has cached or stored the VAL service data of one or more VAL users and/or one or more VAL UEs, it can obtain the VAL service data locally. Alternatively the group management server may obtain the VAL service data from another device such as location management server or configuration management server.

In an embodiment, the group management server may obtain VAL service data of one or more of the at least one VAL user and/or the at least one VAL UE from a location management server.

The location management server is a functional entity that receives and stores user location information and provides user location information to the vertical application server. The location management server may also acquire location information provided by PLMN (Public Land Mobile Network) operator via T8 reference point. The location management server acts as CAPIF's API exposing function as specified in 3GPP TS 23.222 V17.1.0. The location management server also supports interactions with the corresponding location management server in distributed SEAL deployments.

For example, in step 2 of FIG. 3, the group management server may comprise the VAL service ID list or an indication for obtaining the VAL service data in the location request and then the location management server may comprise the known VAL service data in the location response. Alternatively the location management server may always comprise the known VAL service data in the location response regardless whether the first request indicates to provide it or not.

In an embodiment, the first response further comprises VAL service data of one or more of the at least one VAL user and/or the at least one VAL UE. For example, the location management server may provide the VAL service data when the first request indicates to provide it. Alternatively, the location management server may always provide the VAL service data regardless whether the first request indicates to provide it or not.

In an embodiment, the group management server may obtain VAL service data of one or more of the at least one VAL user and/or the at least one VAL UE from a configuration management server.

The configuration management server is a functional entity used to configure one or more vertical applications with 3GPP system related vertical applications provisioning information and configure data on the configuration management client. The configuration management server manages vertical application configuration supported within the vertical's service provider. The configuration management server acts as CAPIF's API exposing function as specified in 3GPP TS 23.222 V17.1.0. The configuration management server also supports interactions with the corresponding configuration management server in distributed SEAL deployments. The configuration management server functional entity is supported by the SIP AS and HTTP server functional entities of the signalling control plane.

In an embodiment, when VAL service ID obtained from the location management server does not comprise one or more of the at least one VAL service identity received in the location based group creation request, the group management server may obtain the VAL service data of the VAL user or the VAL UE from the configuration management server.

At block 508, the group management server may create a location based group matching the location based group creation request based on the VAL service data of the at least one VAL user and/or at least one VAL UE.

For example, during the group creation, the group management server creates and stores the information of the location-based group. The group management server performs the check on the policies e.g. maximum limit of the total number of VAL group members for the VAL group(s). If an external group identifier, identifying the member UEs of the VAL group at the 3GPP core network is available, then the external group ID is stored in the newly created VAL group's configuration information. If VAL service ID list was received at block 502 as part of group formation criteria and not in the first response for the composed list of users or UEs, the group management server shall retrieve the VAL service data from the configuration management server and form the group with relevant users or UEs.

At block 510, optionally, the group management server may store information of the location based group.

At block 512, optionally, the group management server may send a location based group creation response to the group management client or the VAL server.

For example, the location-based group creation response may comprise VAL group ID of the group and result indicating the success or failure for the operation. If the result information element indicates failure then the value of VAL group ID information element has no meaning.

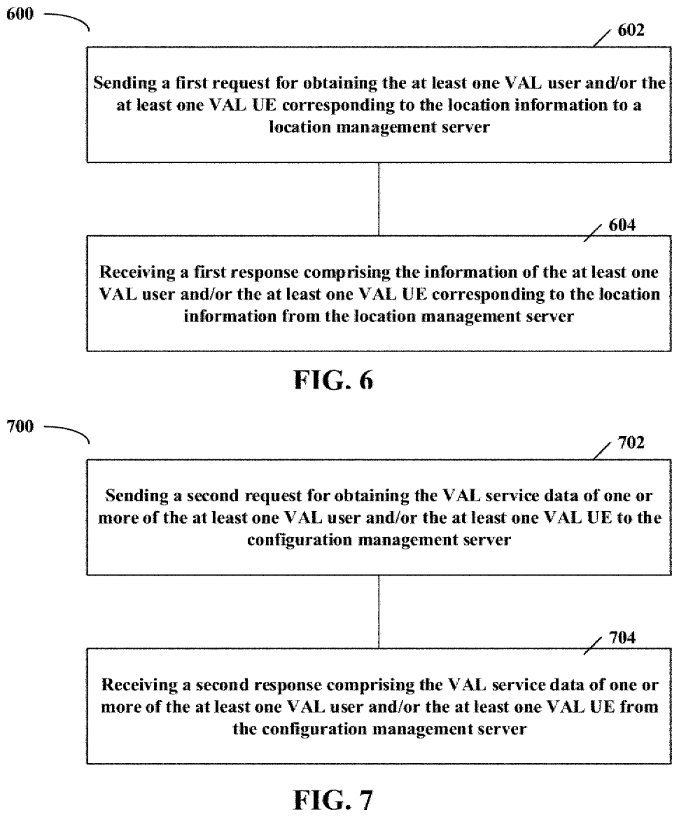

FIG. 6 shows a flowchart of a method according to another embodiment of the present disclosure, which may be performed by an apparatus implemented in or at or as a group management server or communicatively coupled to the group management server. As such, the apparatus may provide means or modules for accomplishing various parts of the method 600 as well as means or modules for accomplishing other processes in conjunction with other components. For some parts which have been described in the above embodiments, detailed description thereof is omitted here for brevity.

At block 602, the group management server may send a first request for obtaining the at least one VAL user and/or the at least one VAL UE corresponding to the location information to a location management server. In an embodiment, block 602 is same as step 2 of FIG. 3.

At block 604, the group management server may receive a first response comprising the information of the at least one VAL user and/or the at least one VAL UE corresponding to the location information from the location management server. For example, the location management server composes the list of users or UEs within the requested location. The location management server may utilize the monitoring capability for “Number of UEs present in a geographical area” provided by SCEF/NEF to retrieve all UE identifiers within the designated geographical area. The group management server receives the composed list of users or UEs from the location management server. In an embodiment, the location management server may include VAL service IDs associated with the list of users or UEs.

FIG. 7 shows a flowchart of a method according to another embodiment of the present disclosure, which may be performed by an apparatus implemented in or at or as a group management server or communicatively coupled to the group management server. As such, the apparatus may provide means or modules for accomplishing various parts of the method 700 as well as means or modules for accomplishing other processes in conjunction with other components. For some parts which have been described in the above embodiments, detailed description thereof is omitted here for brevity.

In this embodiment, the configuration management server has VAL service data maintained for at least one VAL user and/or at least one VAL UE.

At block 702, the group management server may send a second request for obtaining the VAL service data of one or more of the at least one VAL user and/or the at least one VAL UE to the configuration management server.

For example, the group management server may send the second request to the configuration management server when VAL service data of a VAL user or a VAL UE obtained from the location management server does not comprise one or more of the at least one VAL service identity or the location management server does not provide VAL service data to the group management server.

In an embodiment, the second request may comprise at least one of an identity of an entity performing the second request, at least one VAL user ID, at least one VAL UE ID, or at least one VAL service ID.

For example, a consumer (e.g. group management server) sends a get VAL service request to the configuration management server for obtaining VAL service data. The request includes a list of VAL UE IDs or VAL user IDs and/or a VAL service ID list as service data retrieval filters.

At block 704, the group management server may receive a second response comprising the VAL service data of one or more of the at least one VAL user and/or the at least one VAL UE from the configuration management server.

For example, the configuration management server retrieves the VAL service data for the requested VAL UEs or users or VAL services and sends a get VAL service response to the consumer (e.g. group management server) with the discovered list of VAL service data.

In an embodiment, the second response further comprises a result indicating success or failure for the second request.

In an embodiment, when the second request comprises one or more VAL service IDs, the one or more VAL service IDs are used as a first service data retrieval filter and the second response comprises the VAL service data filtered by the first service data retrieval filter,

In an embodiment, when the second request comprises one or more VAL user IDs and/or one or more VAL UE IDs, the one or more VAL user IDs and/or the one or more VAL UE IDs are used as a second service data retrieval filter and the second response comprises the VAL service data filtered by the second service data retrieval filter,

In an embodiment, when the second request comprises both the one or more VAL service IDs and the one or more VAL user IDs and/or the one or more VAL UE IDs, the one or more VAL service IDs and the one or more VAL user IDs and/or the one or more VAL UE IDs are used as a third service data retrieval filter and the second response comprises the VAL service data filtered by the third service data retrieval filter.

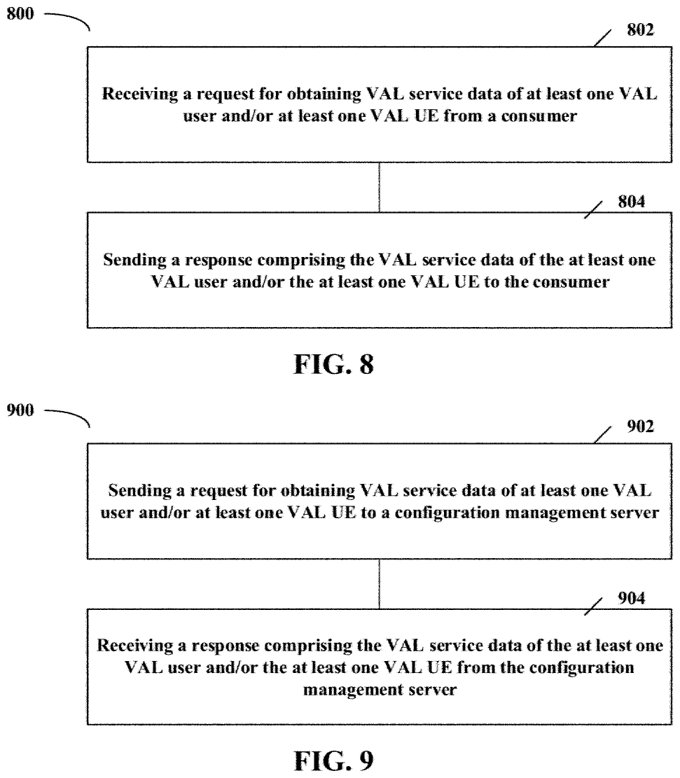

FIG. 8 shows a flowchart of a method according to another embodiment of the present disclosure, which may be performed by an apparatus implemented in or at or as a configuration management server or communicatively coupled to the configuration management server. As such, the apparatus may provide means or modules for accomplishing various parts of the method 800 as well as means or modules for accomplishing other processes in conjunction with other components. For some parts which have been described in the above embodiments, detailed description thereof is omitted here for brevity.

At block 802, the configuration management server may receive a request for obtaining VAL service data of at least one VAL user and/or at least one VAL UE from a consumer.

The consumer may be any suitable function in the VAL system such as group management client, group management server (GMS), VAL server, location management server (LMS), etc.

In an embodiment, the consumer comprises at least one of a group management server, a group management client, or a VAL server.

At block 804, the configuration management server may send a response comprising the VAL service data of the at least one VAL user and/or the at least one VAL UE to the consumer.

In an embodiment, the request comprises at least one of an identity of an entity performing the request, at least one VAL user ID, at least one VAL UE ID, or at least one VAL service ID.

In an embodiment, the response further comprises a result indicating success or failure for the request.

In an embodiment, when the request comprises one or more VAL service IDs, the one or more VAL service IDs are used as a first service data retrieval filter and the response comprises the VAL service data filtered by the first service data retrieval filter.

In an embodiment, when the request comprises one or more VAL user IDs and/or one or more VAL UE IDs, the one or more VAL user IDs and/or the one or more VAL UE IDs are used as a second service data retrieval filter and the response comprises the VAL service data filtered by the second service data retrieval filter.

In an embodiment, when the request comprises both the one or more VAL service IDs and the one or more VAL user IDs and/or the one or more VAL UE IDs, the one or more VAL service IDs and the one or more VAL user IDs and/or the one or more VAL UE IDs are used as a third service data retrieval filter and the response comprises the VAL service data filtered by the third service data retrieval filter.

In an embodiment, the configuration management server has VAL service data maintained for at least one VAL UE and/or at least one VAL user.

In an embodiment, VAL service data of a VAL user or a VAL UE comprises at least one of one or more VAL service IDs of one or more VAL services supported by the VAL user or the VAL UE, a VAL user ID, a VAL UE ID, or VAL service specific information.

In an embodiment, the VAL service data of the at least one VAL user and/or the at least one VAL UE is used by the consumer to form a location based group with at least one desired VAL service.

FIG. 9 shows a flowchart of a method according to another embodiment of the present disclosure, which may be performed by an apparatus implemented in or at or as a consumer or communicatively coupled to the consumer. As such, the apparatus may provide means or modules for accomplishing various parts of the method 900 as well as means or modules for accomplishing other processes in conjunction with other components. For some parts which have been described in the above embodiments, detailed description thereof is omitted here for brevity.

At block 902, the consumer may send a request for obtaining VAL service data of at least one VAL user and/or at least one VAL UE to a configuration management server.

At block 904, the consumer may receive a response comprising the VAL service data of the at least one VAL user and/or the at least one VAL UE from the configuration management server.

In an embodiment, the consumer comprises at least one of a group management server, a group management client, or a VAL server.

In an embodiment, the request comprises at least one of an identity of an entity performing the request, at least one VAL user ID, at least one VAL UE ID, or at least one VAL service ID.

In an embodiment, the response further comprises a result indicating success or failure for the request.

In an embodiment, when the request comprises one or more VAL service IDs, the one or more VAL service IDs are used as a first service data retrieval filter and the response comprises the VAL service data filtered by the first service data retrieval filter.

In an embodiment, when the request comprises one or more VAL user IDs and/or one or more VAL UE IDs, the one or more VAL user IDs and/or the one or more VAL UE IDs are used as a second service data retrieval filter and the response comprises the VAL service data filtered by the second service data retrieval filter.

In an embodiment, when the request comprises both the one or more VAL service IDs and the one or more VAL user IDs and/or the one or more VAL UE IDs, the one or more VAL service IDs and the one or more VAL user IDs and/or the one or more VAL UE IDs are used as a third service data retrieval filter and the response comprises the VAL service data filtered by the third service data retrieval filter.

In an embodiment, the configuration management server has VAL service data maintained for at least one VAL UE and/or at least one VAL user.

In an embodiment, VAL service data of a VAL user or a VAL UE comprises at least one of one or more VAL service IDs of one or more VAL services supported by the VAL user or the VAL UE, a VAL user ID, a VAL UE ID, or VAL service specific information.

In an embodiment, the VAL service data of the at least one VAL user and/or the at least one VAL UE is used by the consumer to form a location based group with at least one desired VAL service.

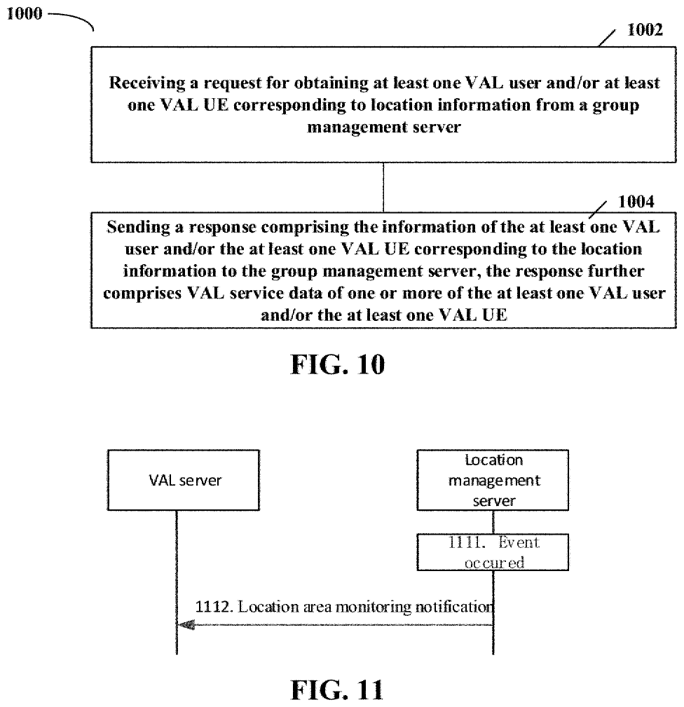

FIG. 10 shows a flowchart of a method according to another embodiment of the present disclosure, which may be performed by an apparatus implemented in or at or as a location management server or communicatively coupled to the location management server. As such, the apparatus may provide means or modules for accomplishing various parts of the method 1000 as well as means or modules for accomplishing other processes in conjunction with other components. For some parts which have been described in the above embodiments, detailed description thereof is omitted here for brevity.

The location management server may maintain or cache VAL service data for at least one VAL user and/or at least one VAL UE.

At block 1002, the location management server may receive a request for obtaining at least one VAL user and/or at least one VAL UE corresponding to location information from a group management server.

At block 1004, the location management server may send a response comprising the information of the at least one VAL user and/or the at least one VAL UE corresponding to the location information to the group management server. The response further comprises VAL service data of one or more of the at least one VAL user and/or the at least one VAL UE.

In an embodiment, VAL service data of a VAL user or a VAL UE comprises at least one of one or more VAL service IDs of one or more VAL services supported by the VAL user or the VAL UE, a VAL user ID, a VAL UE ID, or VAL service specific information.

FIG. 11 shows a flowchart of location area monitoring notification procedure according to an embodiment of the present disclosure.

The same procedure can be applied for location management client and other SEAL servers who have subscribe to the list of the UEs moving in or moving out of the specific location area.

At step 1111. One of the events occurs at the location management server as specified in the subscribe request. The location management server identifies the UEs which are moved into the area or moved out of the area based on their location data and time stamp of the location. The LMS may report the list of all UEs in the given location or UEs moved in and moved out. The monitoring capability for “Number of UEs present in a geographical area” provided by SCEF/NEF may be used by the LMS to retrieve all UE VAL service identities within the designated geographical area.

NOTE: The reference UE and the application defined proximity range from the reference UE to be monitored can be expressed in a geographic area (e.g. circular shape) by the LMS after retrieving the location of the reference UE.

At step 1112. The location management server sends a location area monitoring notification to the VAL server. In the notification message, the location management server includes the information as specified in Table 2 which is same as Table 9.3.2.16-1 of 3GPP TS 23.434 V17.4.0.

Table 2 describes the information flow from the location management server to the VAL server.

TABLE 2
Location area monitoring notification

| Information element | Status | Description |
|---|---|---|
| Subscription identity | M | Identity of the subscription |
| UEs currently present | O | List of the identities of all VAL |
| (NOTE) | | UEs who are currently present in |
| | | the given location area |
| UEs moved in/out | O | List of UEs either moved in to the |
| (NOTE) | | location area or moved out of the |
| | | location area |
| >> UEs moved in | O | List of the identities of the VAL UEs |
| | | who moved in to the given location |
| | | area since previous notification. |
| >> UEs moved out | O | List of the identities of the VAL UEs |
| | | who moved out of the given location |
| | | area since previous notification. |
| Triggering event | O | Identity of the event that triggered |
| | | the sending of the notification |

(NOTE):
Any one of these shall be present.

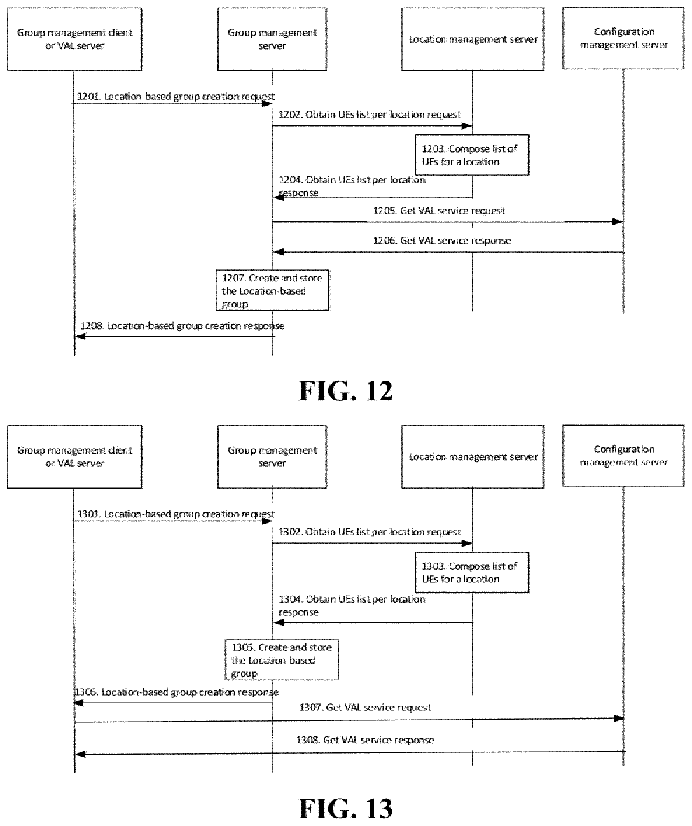

FIG. 12 shows a flowchart of location-based group creation procedure according to an embodiment of the present disclosure.

### Pre-Conditions:

1. The group management client, group management server, VAL server, location management server and the VAL group members belong to the same VAL system.

2. The authorized VAL user/UE/administrator is not aware of the users' or UE identities which will be combined to form the VAL group.

At step 1201. The group management client or the VAL server requests location-based group create operation to the group management server. The location criteria for determining the identities of the users or UEs to be combined shall be included in this message.

At step 1202. The group management server requests the location management server for obtaining the users or UEs corresponding to the location information.

At step 1203. The location management server composes the list of users or UEs within the requested location. The location management server may utilize the monitoring capability for “Number of UEs present in a geographical area” provided by SCEF/NEF to retrieve all UE identities within the designated geographical area.

At step 1204. The group management server receives the composed list of users or UEs from the location management server. The location management server may include VAL service IDs associated with the list of users or UEs.

At step 1205. If VAL service ID list was received in step 1201 as part of group formation criteria and the location management server does not include VAL service IDs associated with the composed list of users or UEs in step 1204, the group management server may retrieve the VAL service data from the configuration management server. For example, the group management server sends Get VAL service request to the configuration management server.

At step 1206. The group management server receives Get VAL service response from the configuration management server. The Get VAL service response may include the requested VAL service data.

At step 1207. During the group creation, the group management server creates and stores the information of the location-based group. The group management server performs the check on the policies e.g. maximum limit of the total number of VAL group members for the VAL group(s). If an external group identifier, identifying the member UEs of the VAL group at the 3GPP core network is available, then the external group ID is stored in the newly created VAL group's configuration information. When VAL service ID list was received in step 1201, the group management server may create and store the information of the location-based group with the VAL service(s) identified by the VAL service ID list. The group is formed considering the VAL service data received from the configuration management server so that each VAL group member supports the desired VAL service(s) received in step 1201.

At step 1208. The group management server provides a location-based group creation response to the group management client or the VAL server.

FIG. 13 shows a flowchart of location-based group creation procedure according to another embodiment of the present disclosure.

### Pre-Conditions:

1. The group management client, group management server, VAL server, location management server and the VAL group members belong to the same VAL system.

2. The authorized VAL user/UE/administrator is not aware of the users' or UE identities which will be combined to form the VAL group.

At step 1301. The group management client or the VAL server requests location-based group create operation to the group management server. The location criteria for determining the identities of the users or UEs to be combined shall be included in this message.

At step 1302. The group management server requests the location management server for obtaining the users or UEs corresponding to the location information.

At step 1303. The location management server composes the list of users or UEs within the requested location. The location management server may utilize the monitoring capability for “Number of UEs present in a geographical area” provided by SCEF/NEF to retrieve all UE identities within the designated geographical area.

At step 1304. The group management server receives the composed list of users or UEs from the location management server. The location management server may include VAL service IDs associated with the list of users or UEs.

At step 1305. During the group creation, the group management server creates and stores the information of the location-based group. The group management server performs the check on the policies e.g. maximum limit of the total number of VAL group members for the VAL group(s). If an external group identifier, identifying the member UEs of the VAL group at the 3GPP core network is available, then the external group ID is stored in the newly created VAL group's configuration information.

At step 1306. The group management server provides a location-based group creation response to the group management client or the VAL server.

At step 1307. The group management client or the VAL server sends Get VAL service request to the configuration management server.

At step 1308. The group management client or the VAL server receives Get VAL service response from the configuration management server.

In this embodiment, the group management client or the VAL server doesn't send VAL service ID to the group management server. The group formation can be finally decided by the group management client or the VAL server.

Table 3 describes the information flow of get VAL service request from the group management server or the group management client or the VAL server to the configuration management server.

TABLE 3
Get VAL service request

| Information element | Status | Description |
|---|---|---|
| Requester Identity | M | The identity of the entity |
| | | performing the request. |
| Identity list | O (NOTE) | The VAL user IDs of the VAL |
| | | user or VAL UE IDs. |
| VAL service ID list | O (NOTE) | The requested VAL service IDs |
| | | for the identity list. |

(NOTE):
At least one of Identity list or VAL service ID list shall be included.

Table 4 describes the information flow of get VAL service response from the configuration management server or the group management client or the VAL server to the group management server.

TABLE 4
Get VAL service response

| Information element | Status | Description |
|---|---|---|
| A list of VAL service | O | One or more VAL service data |
| data | (NOTE 1) | associated with the VAL user |
| | | ID or VAL UE ID provided in |
| | | the associated get VAL service |
| | | request. |
| > Identity | M | The VAL user ID of the VAL user |
| | | or VAL UE ID. |
| > VAL service IDs | M | The supported VAL service IDs. |
| > VAL service specific | O | Placeholder for VAL service |
| information (NOTE 2) | | specific information. |
| Result | M | Indicates the success or failure |
| | | for the operation. |

(NOTE 1):
It is valid when the Result information element indicates success.
(NOTE 2):
The details of this information element are specified in VAL service specific specification and are out scope of the present document.

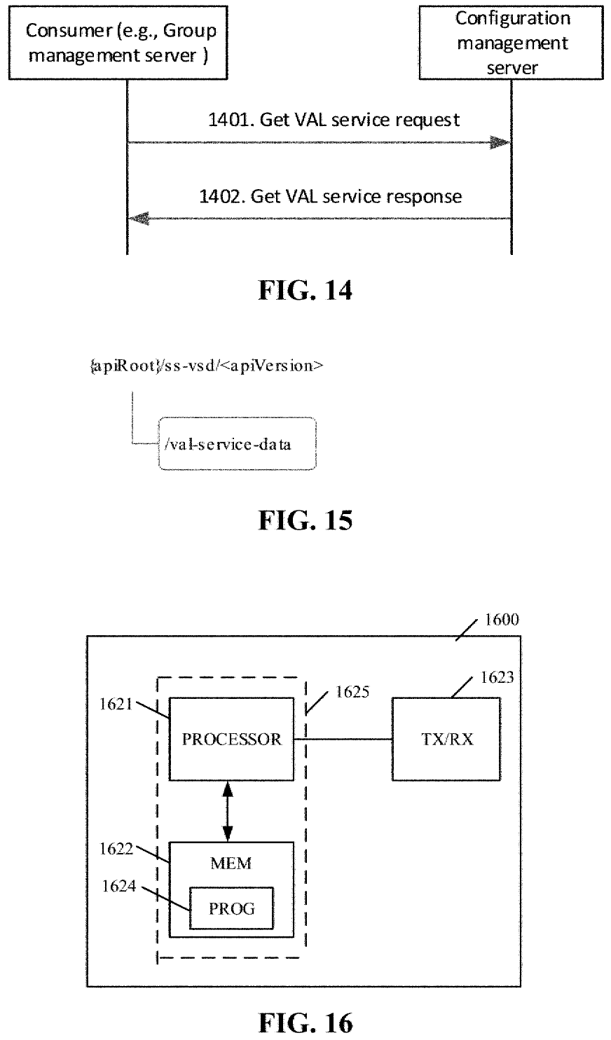

FIG. 14 shows a flowchart of obtaining the VAL service data for VAL UE(s) or VAL user(s) according to another embodiment of the present disclosure.

### Pre-Conditions:

The consumer has the secure access to the configuration management server.
The configuration management server has VAL service data maintained for VAL UE or user.

At step 1401. The consumer (e.g. group management server or the group management client or the VAL server) sends a get VAL service request to the configuration management server for obtaining VAL service data. The request includes a list of VAL UE IDs or VAL user IDs and/or a VAL service ID list as service data retrieval filters.

At step 1402. The configuration management server retrieves the VAL service data for the requested VAL UEs or users or VAL services and sends get VAL service response to the consumer (e.g. group management server) with the discovered list of VAL service data.

In an embodiment, Table 11.4.1-1 of 3GPP TS 23.434 V17.4.0 may be amended as following.

TABLE 11.4.1-1
List of SEAL APIs for configuration management

| | | | Communication |
|---|---|---|---|
| API Name | API Operations | Known Consumer(s) | Type |
| SS_UserProfileRetrieval | Obtain_User_Profile | VAL server | Request/Response |
| SS_UserProfileEvent | Subscribe_User_Profile_Update | VAL server | Subscribe/Notify |
| | Notify_User_Profile_Update | VAL server | |
| SS_VALServiceData | Obtain_VAL_Service_Data | group management | Request/Response |
| | | server | |

In an embodiment, the following content may be added into 3GPP TS 23.434 V17.4.0.

### 11.4.x SS_VALServiceData API

### 11.4.x.1 General

API description: This API enables the group management server to communicate with the configuration management server for obtaining VAL service data over SEAL-X.

11.4.x.2 Obtain VAL_Service_Data operation
API operation name: Obtain_VAL_Service_Data
Description: Obtaining VAL service data.
Known Consumers: group management server.
Inputs: See table 3
Outputs: See table 4
See FIG. 14 for the details of usage of this API operation.

For protocol realization, the following text gives a possible implementation for this new CM service API, which may be added in 3GPP TS 29.549 V17.3.0 (clause numbering follows 3GPP TS 29.549 V17.3.0 document structure):

7.3 Configuration management APIs

### 7.3.2 SS VALServiceData API

### 7.3.2.1 API URI

The SS_VALServiceData service shall use the SS_VALServiceData API.

The request URIs used in HTTP requests from the VAL server towards the Configuration management server shall have the Resource URI structure as defined in clause 6.5 of 3GPP TS 29.549 V17.3.0 with the following clarifications:
The <apiName> shall be “ss-vsd”.
The <apiVersion> shall be “v1”.
The <apiSpecificSuffixes> shall be set as described in clause 7.3.1.2 of 3GPP TS 29.549 V17.3.0.

### 7.3.2.2 Resources

### 7.3.2.2.1 Overview

FIG. 15 shows an example of Resource URI structure of the SS_VALServiceData API according to another embodiment of the present disclosure.

Table 7.3.2.2.1-1 provides an overview of the resources and applicable HTTP methods.

TABLE 7.3.2.2.1-1
Resources and methods overview

| | | HTTP | |
|---|---|---|---|
| | | method or | |
| | | custom | |
| Resource name | Resource URI | operation | Description |
| VAL Service Data | /val-service-data | GET | Retrieve VAL |
| | | | service data |

### 7.3.2.2.2 Resource: VAL Service Data

### 7.3.2.2.2.1 Description

The VAL Services resource represents all the VAL service data that are maintained at a given configuration management server.

### 7.3.2.2.2.2 Resource Definition

Resource URI: {apiRoot}/ss-upr/<apiVersion>/val-service-data

This resource shall support the resource URI variables defined in the table 7.3.2.2.2.2-1.

TABLE 7.3.2.2.2.2-1
Resource URI variables for this resource

| Name | Data Type | Definition |
|---|---|---|
| apiRoot | string | See clause 6.5 |
| apiVersion | string | See clause 7.3.1.1 |

### 7.3.2.2.2.3 Resource Standard Methods

### 7.3.2.2.2.3.1 GET

This operation retrieves VAL User or VAL UE profile information satisfying the filter criteria. This method shall support the URI query parameters specified in table 7.3.2.2.2.3.1-1.

TABLE 7.3.1.2.2.3.1-1
URI query parameters supported by
the GET method on this resource

| | | | Cardi- | |
|---|---|---|---|---|
| Name | Data type | P | nality | Description |
| id-list | array(ValTargetUe) | O | 1 . . . N | Identifying a list |
| | | | | of VAL target UEs. |
| val-service-ids | array(string) | O | 1 . . . N | Identifying a list |
| | | | | of VAL services. |

This method shall support the request data structures specified in table 7.3.2.2.2.3.1-2 and the response data structures and response codes specified in table 7.3.2.2.2.3.1-3.

TABLE 7.3.2.2.2.3.1-2
Data structures supported by the
GET Request Body on this resource

| | | | |
|---|---|---|---|
| Data type | P | Cardinality | Description |

n/a

TABLE 7.3.2.2.2.3.1-3
Data structures supported by the GET
Response Body on this resource

| | | | Re- | |
|---|---|---|---|---|
| | | Cardi- | sponse | |
| Data type | P | nality | codes | Description |
| array(VALService | M | 0 . . . | 200 OK | List of VAL service data. |
| Data) | | N | | This response shall include |
| | | | | information matching the |
| | | | | query parameters provided |
| | | | | in the request. |
| n/a | | | 307 | Temporary redirection, |
| | | | Tempo- | during resource retrieval. |
| | | | rary | The response shall include |
| | | | Redirect | a Location header field |
| | | | | containing an alternative |
| | | | | URI of the resource located |
| | | | | in an alternative configu- |
| | | | | ration management server. |
| | | | | Redirection handling is |
| | | | | described in subclause |
| | | | | 5.2.10 of 3GPP TS 29.122 |
| | | | | [3]. |
| n/a | | | 308 | Permanent redirection, |
| | | | Perma- | during resource retrieval. |
| | | | nent | The response shall include |
| | | | Redirect | a Location header field |
| | | | | containing an alternative |
| | | | | URI of the resource located |
| | | | | in an alternative configu- |
| | | | | ration management server. |
| | | | | Redirection handling is |
| | | | | described in subclause |
| | | | | 5.2.10 of 3GPP TS 29.122 |
| | | | | [3]. |

NOTE:
The mandatory HTTP error status codes for the GET method listed in table 5.2.6-1 of 3GPP TS 29.122 also apply.

TABLE 7.3.2.2.2.3.1-4
Headers supported by the 307 Response Code on this resource

| | Data | | | |
|---|---|---|---|---|
| Name | type | P | Cardinality | Description |
| Location | string | M | 1 | An alternative URI of the |
| | | | | resource located in an |
| | | | | alternative configuration |
| | | | | management server. |

TABLE 7.3.2.2.2.3.1-5
Headers supported by the 308 Response Code on this resource

| | Data | | | |
|---|---|---|---|---|
| Name | type | P | Cardinality | Description |
| Location | string | M | 1 | An alternative URI of the |
| | | | | resource located in an |
| | | | | alternative configuration |
| | | | | management server. |

### 7.3.2.4 Data Model

### 7.3.2.4.1 General

This clause specifies the application data model supported by the API. Data types listed in clause 6.2 apply to this API

Table 7.3.2.4.1-1 specifies the data types defined specifically for the SS_VALServiceData API service.

TABLE 7.3.2.4.1-1
SS_VALServiceData API specific Data Types

| | | | |
|---|---|---|---|
| | Section | | |
| Data type | defined | Description | Applicability |

| | |
|---|---|
| VALServiceData | 7.3.2.4.2.2 |

Table 7.3.2.4.1-2 specifies data types re-used by the SS_VALServiceData API service.

TABLE 7.3.2.4.1-2
Re-used Data Types

| | | | |
|---|---|---|---|
| Data type | Reference | Comments | Applicability |

| | |
|---|---|
| ValTargetUc | 7.3.1.4.2.3 |

### 7.3.2.4.2 Structured Data Types

### 7.3.2.4.2.1 Introduction

### 7.3.2.4.2.2 Type: VALServiceData

TABLE 7.3.2.4.2.2-1
Definition of type VALServiceData

| | | | | | |
|---|---|---|---|---|---|
| Attribute | | | Cardi- | | Appli- |
| name | Data type | P | nality | Description | cability |

| | | | | |
|---|---|---|---|---|
| valTgtUe | ValTargetUe | M | 1 | Unique identifier |
| | | | | of a VAL user or |
| | | | | a VAL UE. |
| valServiceIds | array(string) | M | 1 . . . N | The VAL service |
| | | | | ID list. |
| VAL service | string | O | 0 . . . 1 | Placeholder for |
| specific | | | | VAL service |
| information | | | | specific |
| (see NOTE 2) | | | | information |

The various blocks shown in figures may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

Embodiments herein afford many advantages, of which a non-exhaustive list of examples follows. In some embodiments herein, the proposed solution can avoid incorrect VAL users or UEs (supporting different VAL service than the VAL server) being included into a location based group. In some embodiments herein, the proposed solution can identify the supported VAL services for the retrieved VAL users or UEs within an area. The embodiments herein are not limited to the features and advantages mentioned above. A person skilled in the art will recognize additional features and advantages upon reading the following detailed description.

FIG. 16 is a block diagram showing an apparatus suitable for practicing some embodiments of the disclosure. For example, any one of the group management server, the configuration management server, the location management server or the consumer described above may be implemented as or through the apparatus 1600.

The apparatus 1600 comprises at least one processor 1621, such as a digital processor (DP), and at least one memory (MEM) 1622 coupled to the processor 1621. The apparatus 1616 may further comprise a transmitter TX and receiver RX 1623 coupled to the processor 1621. The MEM 1622 stores a program (PROG) 1624. The PROG 1624 may include instructions that, when executed on the associated processor 1621, enable the apparatus 1616 to operate in accordance with the embodiments of the present disclosure. A combination of the at least one processor 1621 and the at least one MEM 1622 may form processing means 1625 adapted to implement various embodiments of the present disclosure.

Various embodiments of the present disclosure may be implemented by computer program executable by one or more of the processor 1621, software, firmware, hardware or in a combination thereof.

The MEM 1622 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1621 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the group management server, the memory 1622 contains instructions executable by the processor 1621, whereby the group management server operates according to any step of the methods related to the group management server as described above.

In an embodiment where the apparatus is implemented as or at the configuration management server, the memory 1622 contains instructions executable by the processor 1621, whereby the configuration management server operates according to any step of the methods related to the configuration management server as described above.

In an embodiment where the apparatus is implemented as or at the consumer, the memory 1622 contains instructions executable by the processor 1621, whereby the consumer operates according to any step of the methods related to the consumer as described above.

In an embodiment where the apparatus is implemented as or at the location management server, the memory 1622 contains instructions executable by the processor 1621, whereby the location management server operates according to any step of any of the methods related to the location management server as described above.

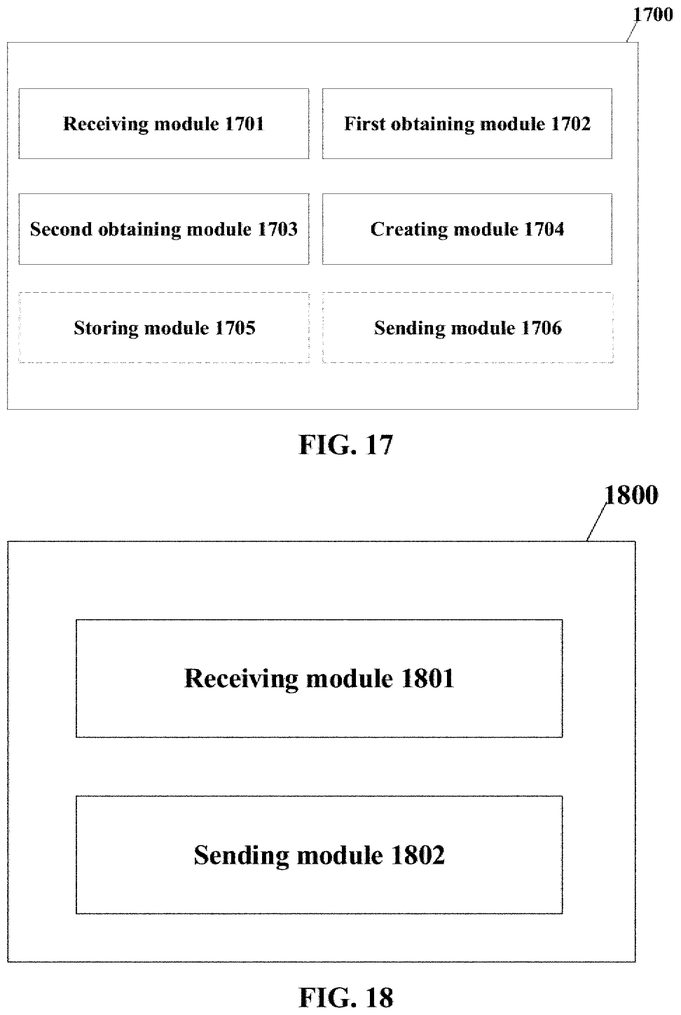

FIG. 17 is a block diagram showing a group management server according to an embodiment of the disclosure. As shown, the group management server 1700 comprises a receiving module 1701 configured to receive a location based group creation request from a group management client or a vertical application layer (VAL) server. The location based group creation request comprises location information and at least one VAL service identity (ID). The group management server 1700 further comprises a first obtaining module 1702 configured to obtain information of at least one VAL user and/or at least one VAL user equipment (UE) corresponding to the location information. The group management server 1700 further comprises a second obtaining module 1703 configured to obtain VAL service data of the at least one VAL user and/or the at least one VAL UE. The group management server 1700 further comprises a creating module 1704 configured to create a location based group matching the location based group creation request based on the VAL service data of the at least one VAL user and/or at least one VAL UE.

In an embodiment, the group management server 1700 further comprises a storing module 1705 configured to store information of the location based group.

In an embodiment, the group management server 1700 further comprises a sending module 1706 configured to send a location based group creation response to the group management client or the VAL server.

FIG. 18 is a block diagram showing a configuration management server according to an embodiment of the disclosure. As shown, the configuration management server 1800 comprises a receiving module 1801 configured to receive a request for obtaining VAL service data of at least one VAL user and/or at least one VAL UE from a consumer. The configuration management server 1800 further comprises a sending module 1802 configured to send a response comprising the VAL service data of the at least one VAL user and/or the at least one VAL UE to the consumer.

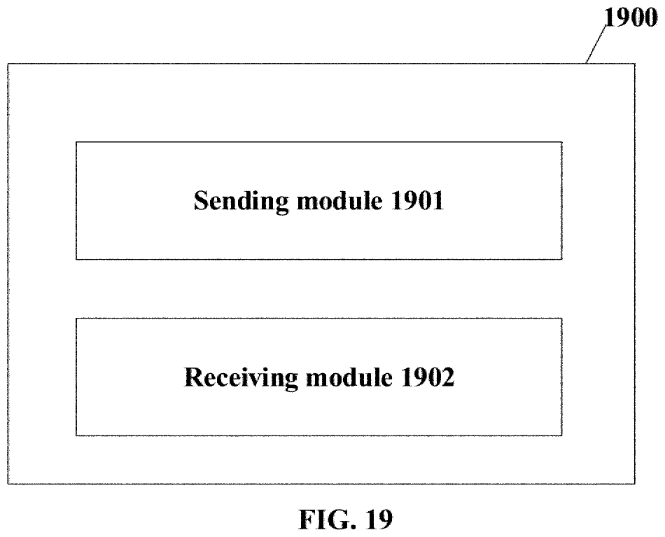

FIG. 19 is a block diagram showing a consumer according to an embodiment of the disclosure. As shown, the consumer 1900 comprises a sending module 1901 configured to send a request for obtaining VAL service data of at least one VAL user and/or at least one VAL UE to a configuration management server. The consumer 1900 further comprises a receiving module 1902 configured to receive a response comprising the VAL service data of the at least one VAL user and/or the at least one VAL UE from the configuration management server.

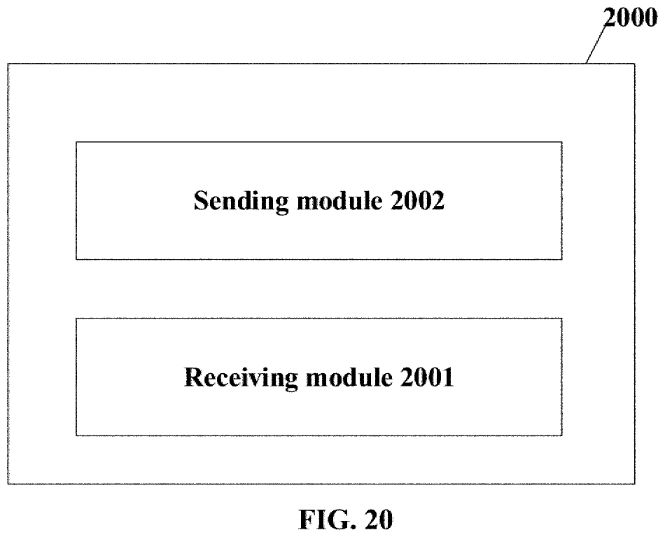

FIG. 20 is a block diagram showing a location management server according to an embodiment of the disclosure. As shown, the location management server 2000 comprises a receiving module 2001 configured to receive a request for obtaining at least one VAL user and/or at least one VAL UE corresponding to location information from a group management server. The location management server 2000 further comprises a sending module 2002 configured to send a response comprising the information of the at least one VAL user and/or the at least one VAL UE corresponding to the location information to the group management server.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the group management server, the configuration management server, the location management server or the consumer may not need a fixed processor or memory, any computing resource and storage resource may be arranged from the group management server, the configuration management server, the location management server or the consumer in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a group management server, comprising:
receiving a location based group creation request from a group management client or a vertical application layer server, wherein the location based group creation request comprises location information and at least one VAL service identity;
obtaining information of at least one VAL user and/or at least one VAL user equipment corresponding to the location information;
obtaining VAL service data of the at least one VAL user and/or the at least one VAL UE;
creating a location based group matching the location based group creation request based on the VAL service data of the at least one VAL user and/or at least one VAL UE.

2. (canceled)

3. The method according to claim 1, wherein obtaining information of the at least one VAL user and/or the at least one VAL UE corresponding to the location information comprises:
sending a first request for obtaining the at least one VAL user and/or the at least one VAL UE corresponding to the location information to a location management server; and
receiving a first response comprising the information of the at least one VAL user and/or the at least one VAL UE corresponding to the location information from the location management server.

4. The method according to claim 3, wherein the first response further comprises VAL service data of one or more of the at least one VAL user and/or the at least one VAL UE.

5. The method according to claim 1, wherein obtaining VAL service data of the at least one VAL user and/or the at least one VAL UE comprises at least one of:
obtaining VAL service data of one or more of the at least one VAL user and/or the at least one VAL UE from a location management server; or
obtaining VAL service data of one or more of the at least one VAL user and/or the at least one VAL UE from a configuration management server.

6. The method according to claim 5, wherein obtaining VAL service data of one or more of the at least one VAL user and/or the at least one VAL UE from a configuration management server comprises:
when VAL service ID associated with the at least one VAL user and/or the at least one VAL UE not obtained from the location management server, retrieving the VAL service data of the VAL user or the VALUE from the configuration management server.

7. The method according to claim 5 or 6, wherein obtaining VAL service data of one or more of the at least one VAL user and/or the at least one VAL UE from a configuration management server comprises:
sending a second request for obtaining the VAL service data of one or more of the at least one VAL user and/or the at least one VAL UE to the configuration management server; and
receiving a second response comprising the VAL service data of one or more of the at least one VAL user and/or the at least one VAL UE from the configuration management server.

8. The method according to claim 7, wherein the second request comprises at least one of:
an identity of an entity performing the second request,
at least one VAL user ID,
at least one VAL UE ID, or
at least one VAL service ID.

9. The method according to claim 7, wherein the second response further comprises a result indicating success or failure for the second request.

10. The method according to claim 7, wherein
when the second request comprises one or more VAL service IDs, the one or more VAL service IDs are used as a first service data retrieval filter and the second response comprises the VAL service data filtered by the first service data retrieval filter,
when the second request comprises one or more VAL user IDs and/or one or more VAL UE IDs, the one or more VAL user IDs and/or the one or more VAL UE IDs are used as a second service data retrieval filter and the second response comprises the VAL service data filtered by the second service data retrieval filter,
when the second request comprises both the one or more VAL service IDs and the one or more VAL user IDs and/or the one or more VAL UE IDs, the one or more VAL service IDs and the one or more VAL user IDs and/or the one or more VAL UE IDs are used as a third service data retrieval filter and the second response comprises the VAL service data filtered by the third service data retrieval filter.

11. (canceled)

12. The method according to claim 1, wherein VAL service data of a VAL user or a VAL UE comprises at least one of:
one or more VAL service IDs of one or more VAL services supported by the VAL user or the VAL UE,
a VAL user ID,
a VAL UE ID, or
VAL service specific information.

13. A method performed by a configuration management server, comprising:
receiving a request for obtaining VAL service data of at least one VAL user and/or at least one VAL UE from a consumer; and
sending a response comprising the VAL service data of the at least one VAL user and/or the at least one VAL UE to the consumer.

14. The method according to claim 13, wherein the request comprises at least one of:
an identity of an entity performing the request,
at least one VAL user ID,
at least one VAL UE ID, or
at least one VAL service ID.

15. (canceled)

16. The method according to claim 13, wherein
when the request comprises one or more VAL service IDs, the one or more VAL service IDs are used as a first service data retrieval filter and the response comprises the VAL service data filtered by the first service data retrieval filter,
when the request comprises one or more VAL user IDs and/or one or more VAL UE IDs, the one or more VAL user IDs and/or the one or more VAL UE IDs are used as a second service data retrieval filter and the response comprises the VAL service data filtered by the second service data retrieval filter,
when the request comprises both the one or more VAL service IDs and the one or more VAL user IDs and/or the one or more VAL UE IDs, the one or more VAL service IDs and the one or more VAL user IDs and/or the one or more VAL UE IDs are used as a third service data retrieval filter and the response comprises the VAL service data filtered by the third service data retrieval filter.

17. The method according to claim 13, wherein the configuration management server has VAL service data maintained for at least one VAL UE and/or at least one VAL user.

18. The method according to claim 13, wherein VAL service data of a VAL user or a VAL UE comprises at least one of:
one or more VAL service IDs of one or more VAL services supported by the VAL user or the VAL UE,
a VAL user ID,
a VAL UE ID, or
VAL service specific information.

19. (canceled)

20. (canceled)

21. A method performed by a consumer, comprising:
sending a request for obtaining VAL service data of at least one VAL user and/or at least one VAL UE to a configuration management server; and
receiving a response comprising the VAL service data of the at least one VAL user and/or the at least one VAL UE from the configuration management server.

22. The method according to claim 21, wherein the request comprises at least one of:
an identity of an entity performing the request,
at least one VAL user ID,
at least one VAL UE ID, or
at least one VAL service ID.

23. (canceled)

24. The method according to claim 21, wherein
when the request comprises one or more VAL service IDs, the one or more VAL service IDs are used as a first service data retrieval filter and the response comprises the VAL service data filtered by the first service data retrieval filter,
when the request comprises one or more VAL user IDs and/or one or more VAL UE IDs, the one or more VAL user IDs and/or the one or more VAL UE IDs are used as a second service data retrieval filter and the response comprises the VAL service data filtered by the second service data retrieval filter,
when the request comprises both the one or more VAL service IDs and the one or more VAL user IDs and/or the one or more VAL UE IDs, the one or more VAL service IDs and the one or more VAL user IDs and/or the one or more VAL UE IDs are used as a third service data retrieval filter and the response comprises the VAL service data filtered by the third service data retrieval filter.

25. The method according to claim 21, wherein the configuration management server has VAL service data maintained for at least one VAL UE and/or at least one VAL user.

26. The method according to claim 21, wherein VAL service data of a VAL user or a VAL UE comprises at least one of:
one or more VAL service IDs of one or more VAL services supported by the VAL user or the VAL UE,
a VAL user ID,
a VAL UE ID, or
VAL service specific information.

27-40. (canceled)
